(19) United States
(12) Patent Application Publication
(10) Pub. No.: US 2016/0086253 A1
(43) Pub. Date: Mar. 24, 2016

(54) SHOPPING SYSTEMS AND METHODS FOR PROVIDING REAL-TIME TRANSACTION

(71) Applicant: NATIONAL TSING HUA UNIVERSITY, Hsinchu (TW)

(72) Inventors: Shan-Hung Wu, Hsinchu City (TW); Shao-Kan Pi, Taichung City (TW); Ting-Yu Cheng, Taichung City (TW)

(21) Appl. No.: 14/665,672

(22) Filed: Mar. 23, 2015

(30) Foreign Application Priority Data
Sep. 23, 2014 (TW) 103132721

(51) Int. Cl. G06Q 30/06; G06Q 50/18

(52) U.S. Cl. CPC G06Q 30/0633; G06Q 30/0639; G06Q 50/188; G06Q 30/0617

(57) ABSTRACT

Shopping methods and systems for providing real-time transaction are provided. First, product information of one or more stores neighboring to a plurality of first electronic devices are obtained and transmitted to a server by the first electronic devices. Thereafter, a product list in a database of the server is updated according to the obtained product information and the updated product list is further provided to a second electronic device by the server to enable the second electronic device to select a product therefrom and request a user of the first electronic device for providing a surrogate shopping service of buying the selected product.

### CROSS REFERENCE TO RELATED APPLICATIONS

This application claims the benefit of Taiwan Patent Application No. 103132721, filed Sep. 23, 2014, the entirety of which is incorporated by reference herein.

### BACKGROUND OF THE INVENTION

1. Field of the Invention

The disclosure relates generally to shopping systems and methods, and, more particularly to shopping systems and methods capable of providing real-time surrogate shopping transaction dynamically based on location information.

2. Description of the Related Art

Recently, with vigorous development of Internet, e-commerce has become mainstream of technology applications. Meanwhile, owing to busy in living and great pressure in works, modern people usually don't have time for shopping, so online shopping or surrogate shopping has become a common shopping pattern.

However, there are many shortcomings in conventional online shopping and online surrogate shopping systems. For example, the buyer needs to wait a certain time for the bought products to be delivered after shopping. In addition, although the conventional surrogate shopping systems have been able to provide diversified products, but there are still some specific products unavailable, even that the buyer browsed various surrogate shopping platforms, the only thing could be done is to follow fixed procedure to provide fixed product with fixed price and delivery time.

Moreover, usual surrogate shopping platform only provides Buyer to Customer (B2C) service to provide the surrogate shopping service by professional buying helpers for customers. Owing to the ambiguity of surrogate needs, only minor products may be provided with higher profit, so that those professional buying helpers may only be profitable through buying such products. However, such surrogate shopping platform is unable to be matched with common customer's needs and hard to collect surrogate needs.

### BRIEF SUMMARY OF THE INVENTION

Shopping methods and systems for providing real-time transaction are provided.

In one embodiment, a shopping method for providing real-time transaction is provided. The shopping method includes the following steps. First, product information of one or more stores neighboring to a plurality of first electronic devices are obtained and transmitted to a server by the first electronic devices. Thereafter, a product list in a database of the server is updated according to the obtained product information and the updated product list is further provided to a second electronic device by the server to enable the second electronic device to select a product therefrom and request a user of the first electronic device for providing a surrogate shopping service of buying the selected product.

Another embodiment of the invention provides a shopping system for providing real-time transaction, including a plurality of first electronic devices, a second electronic device and a server. The server is arranged for connecting the first electronic devices and the second electronic device, wherein the server comprises a database having a product list. The first electronic devices obtain product information of one or more stores neighboring to the first electronic devices and transmit the product information to the server, and the server updates the product list in the database of the server according to the obtained product information and provides the updated product list to the second electronic device to enable the second electronic device to select a product therefrom and request a user of the first electronic device for providing a surrogate shopping service of buying the selected product.

Shopping method for providing real-time transaction may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a shopping system for providing real-time transaction of the invention;

FIG. 2 is a flowchart of an embodiment of a shopping method for providing real-time transaction of the invention;

FIG. 3 is a flowchart of another embodiment of a shopping method for providing real-time transaction of the invention; and

FIG. 4 is a schematic diagram illustrating an embodiment of a tracking procedure for tracking the purchasing process of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

Embodiments of the invention provide shopping systems for performing real-time transaction and related shopping methods thereof, which can provide Customer to Customer (C2C) surrogate shopping service platform and its transaction procedure, so that both buyer and buying helper could close the deal more easily, and further ensures interests of both parties and provides services for price negotiation and tracking buyer helpers' progress. Additionally, the embodiments of the invention can further automatically provide surrogate products of stores in the vicinity for possible buyer helpers based on the buyer helper's location, thus increasing the buyer helper's willing to provide the surrogate shopping service. Moreover, the embodiments of the invention can be able to collect product information of stores in the vicinity of buyer helper's location automatically, and use stores' information to update a product list in a database of the server, in turn provides dynamic real-time location product catalogue, thus achieving objectives of real-time transaction.

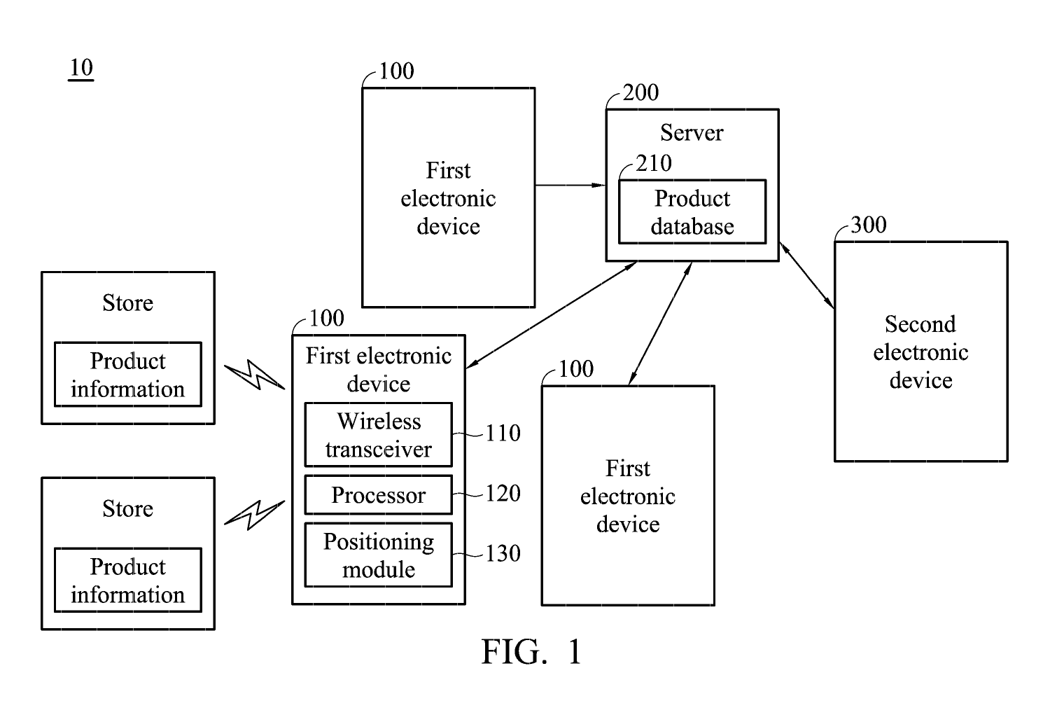

FIG. 1 is a schematic diagram illustrating an embodiment of a shopping system for performing real-time transaction of the invention. As shown in FIG. 1, the shopping system 10 includes at least one or more first electronic device(s) 100, a server 200 and one or more second electronic device(s) 300. The first electronic device(s) 100 and the second electronic device(s) 300 may be the same portable device or other types of wireless devices with positioning and wireless communication capabilities, such as PDAs (Personal Digital Assistant), smartphones, mobile phones, MIDs (Mobile Internet Device), laptop computers, car computers, digital cameras, multi-media players, gaming devices, or any other type of mobile computational devices, however it is to be understood that the invention is not limited thereto. The first electronic device(s) 100 and the second electronic device(s) 300 may connect to the server 200 via a network, such as a wired network (e.g., Internet) and/or a wireless network (e.g., a wireless code division multiple access (WCDMA), 3G, Wireless Local Area Network (WLAN) or Bluetooth network), to mutually execute communication and transfer data through the server 300. The server 200 may include a product database 210, which stores related data, such as, such as lists of various products (e.g., a list of products that can be purchased by the buying helper, a list of products to be purchased and so on). In this embodiment, the user of the first electronic device 100 can be regarded as the possible buying helper and the user of the second electronic device 300 can be regarded as the buyer.

The first electronic device 100 at least comprises a wireless transceiver 110, a processor 120 and a positioning module 130. The wireless transceiver 110 may further comprise a baseband unit (not shown) and a radio frequency (RF) unit (not shown). The baseband unit may contain multiple hardware components to perform baseband signal processing, including analog to digital conversion (ADC)/digital to analog conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the mobile communications system, wherein the radio frequency may be 900 MHz, 1900 MHz, or 2100 MHz utilized in WCDMA systems, or may be 900 MHz, 2100 MHz, or 2.6 GHz utilized in LTE systems, or others depending on the radio access technology (RAT) in use. The processing unit may further control the operation of the wireless communication unit and other functional components, such as a display unit and/or keypad serving as the MMI (man-machine interface), a storage unit (not shown) storing the program codes of applications or communication protocols, or others. The storage unit may be any type of data storage device, such as a built-in memory or an external memory card, which stores any type of data. In some embodiments, the first electronic device 100 may further comprise a display unit (not shown), which can display related data, such as texts, figures, interfaces, and/or information (e.g., map information). It should be understood that, in some embodiments, the display unit may be integrated with a touch-sensitive device (not shown). The touch-sensitive device has a touch-sensitive surface comprising sensors in at least one dimension to detect contact and movement of at least one object (input tool), such as a pen/stylus or finger near or on the touch-sensitive surface. Accordingly, users are able to input commands or signals via the display unit.

The processor 120 which is coupled to the wireless transceiver 110 and the positioning module 130 can perform the shopping method for performing real-time transaction of the present invention, which will be discussed further in the following paragraphs. The processor 120 may be one or more data processors, image processors and/or central processors, which are capable of executing one or more types of computer readable medium stored in a storage device (not shown) such as a memory. The positioning module 130 may be configured to obtain current position of the first electronic device 100. For example, the positioning module 130 can be a GPS sensor (e.g. a GPS receiver), which can receive signals from GPS satellites to obtain a GPS signal, generate a GPS location according to the GPS signal and obtain current position of the first electronic device 100 accordingly.

Similarly, the second electronic device 200 may also comprise a wireless transceiver, a processor and a positioning module as the first electronic device 100, having functions and structures which are similar to those of the first electronic device 100, and thus detail are omitted here for brevity. It should be appreciated that the wireless transceivers, processors and positioning modules of the first electronic device 100 and the second electronic device 200 can have sufficient hardware components to achieve the foregoing functions.

In some embodiments, the shopping methods for performing real-time transaction of the invention can generate and dynamically update the product list comprising a list of products that can be bought maintained in the product database 210 of the server 200 based on product lists provided by the stores in the vicinity of the users of the first electronic devices 100.

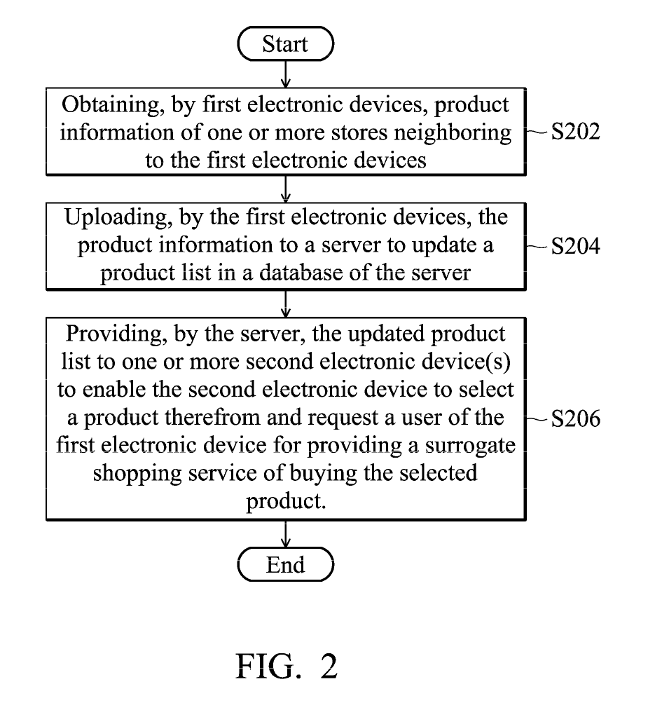

FIG. 2 is a flowchart of an embodiment of a shopping method for providing real-time transaction of the invention. Please refer to FIGS. 1 and 2. The shopping method for providing real-time transaction can be applied to the shopping system 10 as shown in FIG. 1.

First, in step S202, when the user of the first electronic device 100 (such as user on business trip or across border) approaching one or multiple specific stores such as department store, mall or supermarket, the first electronic device 100 may obtain product information of the specific stores automatically through specific wireless communication protocol. To be more specific, the first electronic device 100 may connect to the product databases of these specific stores automatically through the wireless transceiver 110 with specific wireless communication protocol, and obtain the product list from the product databases. The product database is maintained by each specific shop, where it can be updated based on product quantity and status of the stores, thus, the first electronic device 100 can obtain current latest product list.

In some embodiments, the product lists of nearby stores may be collected by using the first electronic device 100 of the user. The product list may automatically transmit to the device of the user from the product database maintained by the nearby store via wireless transmission (e.g., iBeacon, Wifi, Bluetooth, and so on) and the product information may then be uploaded to the server 200 through software program pre-installed in the device. The server 200 may perform a variety of applications based on these product lists, for example, presents the product lists as a list of products that can be currently purchased to a user of other second electronic devices 300. It should be understood that, in the present invention, data collection can be performed through devices automatically, no need for users to perform data collection intentionally. In addition, geographical environment information of the user can be sufficiently used to efficiently collect product information in the vicinity without needing of scanning products one by one.

Further, according to the shopping method for providing real-time transaction of the invention, when the user of the first electronic device 100 is on the move, application app on the first electronic device 100 can automatically obtain store information of stores in the vicinity within a preset range (such as within 5 meters), wherein the store information may include store name, product information etc. and transmit the store information obtained to the server 200. Thus, the server 200 is able to obtain the store information within the range and use the store information to update the product list maintained in the product database 210. Along with user movement, the obtainable stores range also changed accordingly. With the stores information collected around the multiple first electronic devices 100, by the movement of the user themselves, stores information can be dynamically obtainable for the user, thereby real-time location dynamic product list can be provided.

For example, assuming that the specific store is set to be XX mall and products A, B, C, D are currently presented in the product database of the XX mall, when the user of the first electronic device 100 walks through or adjacent to the XX mall, the wireless transceiver in the XX mall can automatically connect to the first electronic device 100 for pairing. Upon completion of the pairing, the first electronic device 100 can automatically connect to the product database of the XX mall using the specific wireless communication protocol via the wireless transceiver 110 and obtain the product information therefrom. In this embodiment, the product list for the XX mall is products A, B, C, D.

After obtaining the product information of the specific store, in step S204, the first electronic device 100 uploads the product list obtained to the server 200 through the wireless transceiver 110 for updating the product list in the product database 210 of the server 200. That is, the products of product list maintained in the product database 210 of the server 200 are dynamically updated according to user location, and only exist when the user is within set range of specific stores. When the user left the set range of the specific stores, those products in the product list will be also removed. In other words, the products of the product list maintained in the product database 210 are all products that can be bought in real-time and the surrogate shopping service can be completed once a subsequent order received, thus providing a convenient surrogate shopping without needs for inventory or unsold products problems.

Then, in step S206, the server 200 transmits the updated product list for surrogate shopping to one or multiple second electronic devices 300 for the second electronic devices 300 to select any product in the product list to generate a surrogate shopping request, so as to request the first electronic device 100 to provide a surrogate shopping service. The surrogate shopping request may include product information and remuneration data related to surrogate shopping products, wherein product information related to the surrogate shopping may include product name, product location and/or product descriptions etc.

When receiving a surrogate shopping request related to a product in the product list from a second electronic device 300, the server 200 transmits this surrogate shopping request to respective first electronic device 100. Thereafter, the user of the first electronic device 100 can determine whether to process surrogate shopping service at will. The surrogate shopping request can further include a remuneration data, showing the amount of money can be obtained with the surrogate shopping service to the user of the first electronic device 100, to enhance willingness of the first electronic device 100's user to provide the surrogate shopping service, and urge the first electronic device 100's user intention to help buying the product.

For example, assume the user of the second electronic device 300 (buyer) happens to be in need of buying product A of XX mall and willing to pay 1000 dollars as remuneration, then can transmit the surrogate shopping request including the product A of XX mall as the product for surrogate shopping and 1000 dollars as the remuneration for the surrogate shopping service to the server 200 through the second electronic device 300, and then the server 200 further transmits the surrogate shopping request to the first electronic device 100 at the vicinity of XX mall, even if the first electronic device 100's user could be not a professional buying helper, but on account of there is only a simple journey required (such as 500 meters distance ahead) for buying designated product A and obtaining the remuneration 1000 dollars, thus the first electronic device 100's user could possibly be willing to provide the surrogate shopping service, to help the second electronic device 300 to buy the product A.

In some embodiments, when the first electronic device 100 receives the surrogate shopping request transmitted from the server 200, it may further provide a route planning service with a map provided on the display unit, and show the path from the current location to the location of XX mall on the map, making it easier for the user of the first electronic device 100 to determine whether to provide the surrogate shopping service.

In some embodiments, if there are multiple first electronic devices 100 existing around the specific store such as the XX mall, the server 200 may simultaneously broadcast the surrogate shopping request generated by the second electronic device including product A of XX mall as the product for surrogate shopping and an amount of 1000 dollars as a remuneration to those first electronic devices 100 in the vicinity, and each user of the first electronic device 100 who is willing to provide the surrogate shopping service may then transmit back a return message to the server 200, wherein the return message may include information regarding estimated buying time and/or related price negotiation information. The server 200 may further transmit these return messages to the second electronic device 300 for selection, thereby increasing success opportunity for the surrogate shopping service.

In some embodiments, the shopping method for providing real-time transaction of the invention can further allow a buyer to transmit a surrogate shopping request including product name for surrogate shopping and remuneration to the server 200 through the second electronic device 300, and then the server 200 further transmits the surrogate shopping request to one or multiple first electronic devices 100 around the product for them to provide the surrogate shopping service.

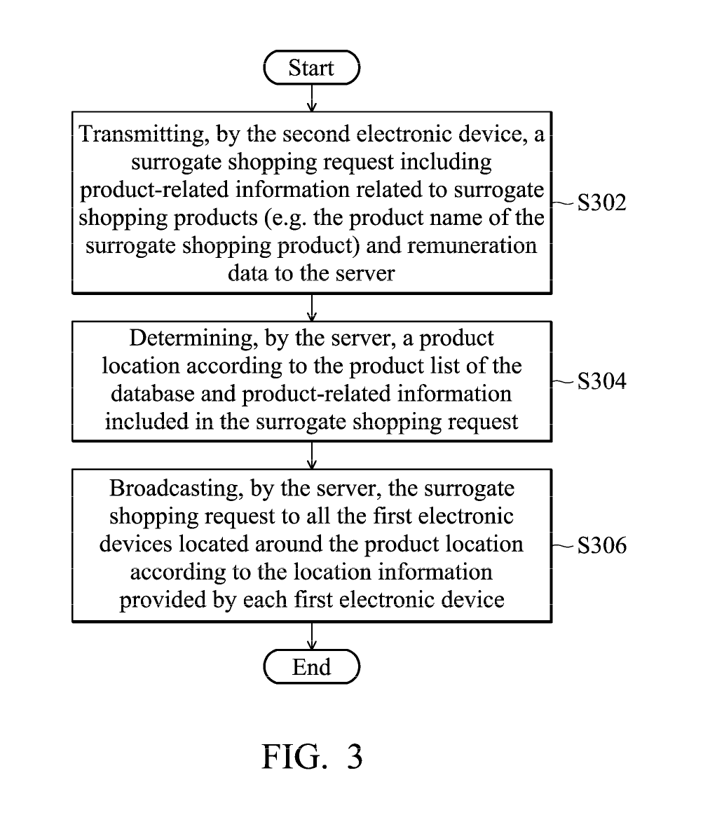

FIG. 3 is a flowchart of an embodiment of a shopping method for providing real-time transaction of the invention. Please refer to FIGS. 1 and 3. The shopping method for providing real-time transaction can be applied to the shopping system 10 as shown in FIG. 1.

First, in step S302, the buyer wants to request for a surrogate shopping service and transmits a surrogate shopping request including product-related information related to surrogate shopping products (e.g. the product name of the surrogate shopping product) and remuneration data to the server 200 through the second electronic device 300.

When receiving the surrogate shopping request from the second electronic device 300, the server 200 finds, in step S304, a product location (such as the aforementioned XX mall) of the product with a name matching with the product name for surrogate shopping indicated by the surrogate shopping request based on the product list currently maintained in the product database 210 and the product-related information in the surrogate shopping request, and broadcasts, in step S306, the surrogate shopping request generated by the second electronic device 300 to all the first electronic devices 100 located around the product location according to the location information provided by the positioning module 130 of each first electronic device 100. To be more specific, the server 200 transmits the surrogate shopping request to all the first electronic devices 100 with a distance to the product location in a given range.

Thereafter, the user of each first electronic device 100 receiving the surrogate shopping request can determine whether to process surrogate shopping service at will. As described above, the surrogate shopping request may further include a remuneration data, showing the amount of money can be obtained with the surrogate shopping service for the user of the first electronic device 100, to enhance willingness of the first electronic device 100's user to provide the surrogate shopping service to help buying the product based on the remuneration data.

For example, assume the user of the second electronic device 300 (buyer) wishes to buy a product B of a Y mall and is willing to pay 500 dollars as remuneration, then he/she can transmit the surrogate shopping request including the product B of the Y mall as the product for surrogate shopping and 500 dollars as the remuneration for the surrogate shopping service to the server 200 through the second electronic device 300, and then the server 200 may further transmit the surrogate shopping request to all the first electronic devices 100 at the vicinity of the Y mall (e.g., those devices with a distance to the Y mall within 10 meters).

In some embodiments, when the first electronic device 100 receives the surrogate shopping request transmitted from the server 200, it may further provide route planning information corresponding to the product location based on the product location, display a map on the display unit, and show the location information of the Y mall and the path from the current location to the location of the Y mall together with the location of the product B within the Y mall on the map to assist the user of each first electronic device 100 to determine whether to provide the surrogate shopping service easily.

When a first electronic device 100 around the Y mall receives the surrogate shopping request from the server 200 and its user is willing to provide the surrogate shopping service, the user may then transmit back a return message indicating a willing to provide the surrogate shopping service to the server 200 using the first electronic device 100. The server 200 may further transmit this return message to the second electronic device 300 of the buyer to inform the buyer that someone is willing to provide the surrogate shopping service and assist in purchasing a contract so as to provide the surrogate shopping service.

For example, a party A (buyer) may raise a surrogate shopping request including “shopping list or wish list” through the second electronic device 300 to the server 200 and later, when a party B (such as seller travelling abroad or on business trip) with the first electronic device 100 in the vicinity of stores of the listed products in “shopping list or wish list”, the first electronic device 100 can show product location information (such as 500 meters ahead), surrogate shopping remuneration and inquiry of whether willing to provide the surrogate shopping service. If the party B were willing to provide the surrogate shopping service, then both parties A and B can sign a contract, and then party B processes the surrogate shopping and obtains the remuneration, and party A obtains the product wanted.

In some embodiments, the shopping method for providing real-time transaction of the invention may further provide optimized trading flow based on user location. When a cross border user located in the vicinity of product with the surrogate shopping request order, the server 200 of the shopping system 10 can perform filtration of geographic location and traffic through data in the product database 210, select surrogate shopping products suitable to the user for surrogate shopping, and present the data to the user through the first electronic device 100 like portable device. Consequently, even if the user did not expect to provide the surrogate shopping service, owing to the incentives of convenience and completeness in data acquiring, and profitability, the user may help to buy the required product, thus trading flow of overall surrogate shopping market can be effectively increased.

In some embodiments, to ensure smooth and safe processing of C2C surrogate shopping service to both buyer and buying helper, the shopping method for providing real-time transaction of the invention further provides a price negotiation procedure and a tracking procedure for tracking the progress of surrogate shopping to supply the first electronic device 100 and the second electronic device 300 bargain and take control of the entire transaction process of surrogate shopping, so as to protect rights and interests of both buyer and buying helper.

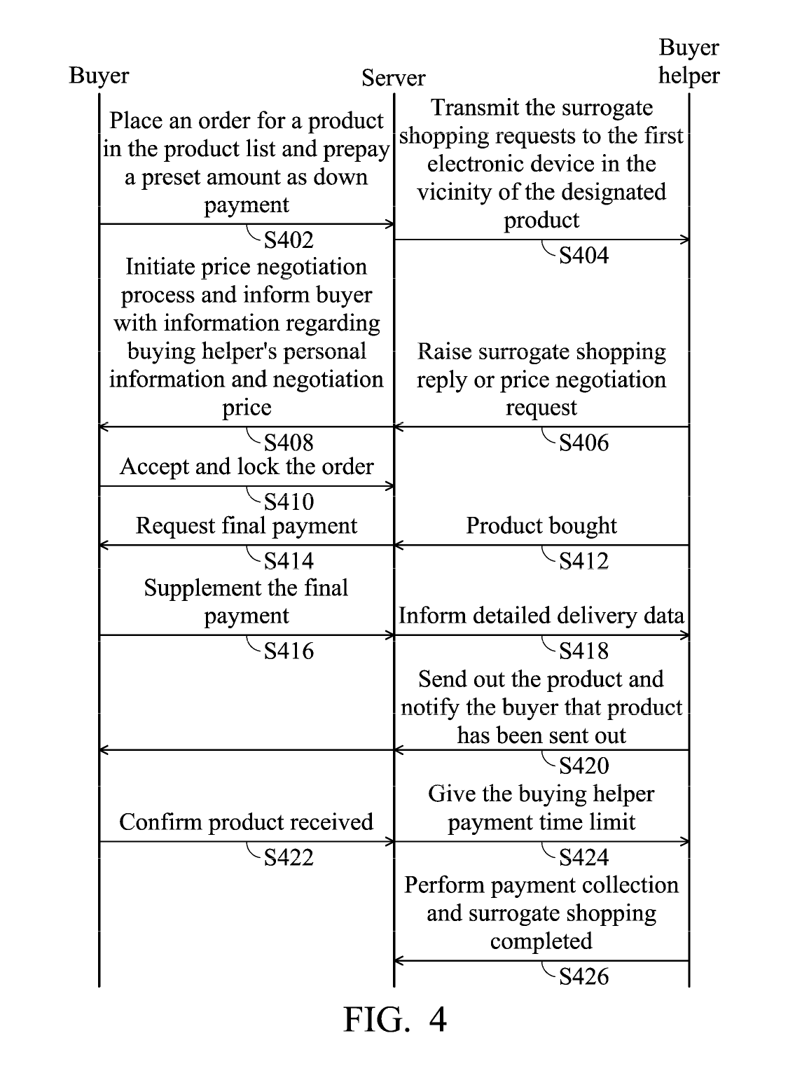

FIG. 4 is a flowchart of an embodiment of a price negotiation procedure and a tracking procedure for tracking the surrogate shopping process for the shopping method for providing real-time transaction of the invention. Please refer to FIGS. 1 and 4. The shopping method for providing real-time transaction can be applied to the shopping system 10 as shown in FIG. 1. In this embodiment, the surrogate shopping process can be divided into phases of waiting, price negotiation, buying, supplementary payment, delivery, confirmation, payment collection and surrogate shopping completion.

First, the buyer places an order for a product in the product list of the product database 210 in the server 200 through the second electronic device 300, with surrogate shopping requests, and prepays a preset amount as down payment (such as 20% of product price), the surrogate shopping process is then in waiting phase (step S402).

Thereafter, the server 200 receives the order and transmits the surrogate shopping requests to the first electronic device 100 in the vicinity of the designated product (step S404).

The buying helper of the first electronic device 100 raises surrogate shopping reply or price negotiation request to the second electronic device 300 through the server 200 (step S406). Then, the server 200 initiates price negotiation process and informs buyer with information regarding buying helper's personal information and negotiation price, wherein the surrogate shopping process is then in price negotiation phase (step S408). The buyer determines whether to accept the negotiation price. If the buying helper did not accept price negotiation or negotiation price, then the buyer can further perform price negotiation with the buying helper through the server 200 or can directly cancel the surrogate shopping or looks for another buying helper.

If the buying helper accepts negotiation price or obtains a new negotiation price through price negotiation process, then the buyer accepts and locks the order through the server 200 (step S410). Then, the server 200 notifies the locked buying helper to perform the surrogate shopping, and the surrogate shopping process is then in buying phase. After buying (step S412), the buying helper requests final payment to the buyer, wherein the surrogate shopping process is then in supplementary payment phase (step S414). Note that the final payment is the amount of product price deducted by down payment, such as, if down payment is 20% of product price, then the final payment is 80% of product price. The buyer can supplement the final payment after final payment request received (step S416), and inform the buying helper detailed delivery data (step S418). After detailed delivery data received, the buying helper sends out the product and notifies the buyer that product has been sent out through the server 200, wherein the surrogate shopping process is then in delivery phase (step S420). After the buyer has received the product, the buyer confirms product received (step S422) in which the surrogate shopping process is then in confirmation phase and gives the buying helper payment time limit through the server 200 in which the surrogate shopping is then in payment collection phase (step S424). The buying helper can perform payment collection within payment time limit, and thus the surrogate shopping is completed in which the surrogate shopping process is then in surrogate shopping completion phase (step S426), showing that an overall surrogate shopping flow smoothly completed.

Therefore, the shopping systems and related methods for providing real-time transaction of the invention can automatically collect product information of stores in the vicinity of the buying helpers, and update the product list of the database in the server by using stores' information collected, thus providing real-time location dynamic product catalogue and achieving the goal of real-time transaction. Moreover, the shopping systems and related methods for providing real-time transaction of the invention can automatically collect surrogate shopping requests through buyer's electronic device, store that to the database in the remote server, and then further transmit that to the electronic device of possible buying helpers for display, so that all needs in the present database can be easily known by the possible buying helpers, and surrogate shopping service opportunities thus enhanced, thereby possible buying helpers are more willing to provide the surrogate shopping service. Furthermore, the shopping systems and related methods for providing real-time transaction of the invention can further provide information related to surrogate shopping list based on location information to cross border moving users, so that they are more willing to become buying helper, and able to dynamically provide personalized surrogate shopping information matched with the present conditions of the buying helper, provide different surrogate shopping choices for the buyer, able to satisfy the buyer with above mentioned information of applicableness, correctness and in-depth variety needs, thus promoting the surrogate shopping service more easily.

Methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A shopping method for providing real-time transaction, comprising:
obtaining, by a plurality of first electronic devices, product information of one or more stores neighboring to the first electronic devices and transmitting the product information to a server; and
updating, by the server, a product list in a database of the server according to the obtained product information and providing the updated product list to a second electronic device to enable the second electronic device to select a product therefrom and request a user of the first electronic device for providing a surrogate shopping service of buying the selected product.

2. The shopping method of claim 1, further comprising:
transmitting, by the second electronic device, a surrogate shopping request corresponding to the selected product to the server;
determining, by the server, a product location of the selected product according to the selected product and the product list of the database; and
transmitting, by the server, the surrogate shopping request to the first electronic devices corresponding to the product location according to location information provided by each of the first electronic devices.

3. The shopping method of claim 2, wherein the server transmits the surrogate shopping request to all of the first electronic devices which are distanced from the product location within a predetermined range.

4. The shopping method of claim 2, wherein each of the first electronic devices further provides a route planning information corresponding to the product location when receiving the surrogate shopping request.

5. The shopping method of claim 2, wherein the surrogate shopping request further comprises product-related information for the product to be bought and remuneration information to encourage the user of the first electronic device to provide the surrogate shopping service of buying the selected product based on the remuneration information.

6. The shopping method of claim 1, wherein the server further provides a price negotiation procedure for price negotiation to the user of the first electronic device and the user of the second electronic device.

7. The shopping method of claim 1, wherein the server further provides a tracking procedure for tracking the surrogate shopping process to control the purchasing process between the first electronic device and the second electronic device.

8. A shopping system for providing real-time transaction, comprising:
a plurality of first electronic devices;
a second electronic device; and
a server for connecting the first electronic devices and the second electronic device, wherein the server comprises a database having a product list;
wherein the first electronic devices obtain product information of one or more stores neighboring to the first electronic devices and transmit the product information to the server, and the server updates the product list in the database of the server according to the obtained product information and provides the updated product list to the second electronic device to enable the second electronic device to select a product therefrom and request a user of the first electronic device for providing a surrogate shopping service of buying the selected product.

9. The shopping system of claim 8, wherein the second electronic device further transmits a surrogate shopping request corresponding to the selected product to the server, and the server further determines a product location of the selected product according to the selected product and the product list of the database and transmits the surrogate shopping request to the first electronic devices corresponding to the product location according to location information provided by each of the first electronic devices.

10. The shopping system of claim 9, wherein the server further transmits the surrogate shopping request to all of the first electronic devices which are distanced from the product location within a predetermined range.

11. The shopping system of claim 9, wherein each of the first electronic devices further provides a route planning information corresponding to the product location when receiving the surrogate shopping request.

12. The shopping system of claim 9, wherein the surrogate shopping request further comprises product-related information for the product to be bought and remuneration information to encourage the user of the first electronic device to provide the surrogate shopping service of buying the selected product based on the remuneration information.

13. The shopping system of claim 8, wherein the server further provides a price negotiation procedure for price negotiation to the user of the first electronic device and the user of the second electronic device.

14. The shopping system of claim 8, wherein the server further provides a tracking procedure for tracking the surrogate shopping process to control the purchasing process between the first electronic device and the second electronic device.
